(19) United States
(12) Patent Application Publication
(10) Pub. No.: US 2026/0326667 A1
(43) Pub. Date: Oct. 22, 2026

(54) VEHICULAR ELECTROCHROMIC MIRROR REFLECTIVE ELEMENT WITH INTEGRATED HEATING ELEMENT

(71) Applicant: Magna Mirrors of America, Inc., Holland, MI (US)

(72) Inventors: Nathan C. Shipaila, Rockford, MI (US); Alexander J. Reau, Wyoming, MI (US); J.R. Scott Mitchell, Newmarket (CA); Gabriele W. Sabatini, Keswick (CA); Traian Miu, Oakville (CA)

(21) Appl. No.: 19/649,271

(22) Filed: Apr. 16, 2026

Related U.S. Application Data
(60) Provisional application No. 63/790,264, filed on Apr. 17, 2025.

(51) Int. Cl. B60R 1/08; B60R 1/04; B60R 1/06; G02B 1/16; G02F 1/155; G02F 1/157; G02F 1/161

(52) U.S. Cl. CPC B60R 1/088; B60R 1/04; B60R 1/0602; G02B 1/16; G02F 1/155; G02F 1/157; G02F 1/161

(57) ABSTRACT

An electrochromic mirror reflective element includes a front substrate having first and second sides, a rear substrate having third and fourth sides, and an electrochromic medium between the front and rear substrates. A transparent electrically conductive coating at the second side contacts the electrochromic medium. An electrically conductive coating at the third side contacts the electrochromic medium. A first electrical connection at the fourth side connects with the coating at the second side. A second electrical connection at the fourth side connects with the coating at the third side. Voltage between the first and second electrical connections electrically dims the electrochromic medium. A heating element including an electrically conductive thin-film coating is disposed at the fourth side. Third and fourth electrical connections at the fourth side connect with the electrically conductive thin-film coating. Voltage between the third and fourth electrical connections generates heat at the mirror reflective element.

### CROSS REFERENCE TO RELATED APPLICATION

The present application claims the filing benefits of U.S. provisional application Ser. No. 63/790,264, filed Apr. 17, 2025, which is hereby incorporated herein by reference in its entirety.

### FIELD OF THE INVENTION

The present invention relates generally to the field of rearview mirror assemblies for vehicles.

### BACKGROUND OF THE INVENTION

It is known to provide an automotive rearview mirror assembly that includes one or more accessories, such as a light source and/or a user input or the like. The mirror reflective element of such known mirror assemblies includes a mirror reflector coating that is vacuum deposited or sputter coated onto a surface of a glass substrate of the mirror reflective element and preferably includes visual indicators such as turn signal indicators and blind zone indicators that indicate to a driver presence of another overtaking vehicle in a side lane adjacent to the equipped vehicle.

### SUMMARY OF THE INVENTION

The present invention provides a rearview mirror assembly (such as an exterior mirror assembly mounted at a side of an equipped vehicle or an interior mirror assembly mounted at an interior portion of an interior cabin of the vehicle) that includes a mirror head disposed at mounting structure, where the mounting structure is configured to mount the vehicular rearview mirror assembly at the vehicle. The mirror head includes a mirror reflective element, such as an electrochromic mirror reflective element. The electrochromic mirror reflective element includes (i) a front glass substrate having a first side and a second side separated from the first side by a thickness of the front glass substrate and (ii) a rear glass substrate having a third side and a fourth side separated from the third side by a thickness of the rear glass substrate. The front glass substrate is joined with the rear glass substrate with an electrochromic medium disposed between the front glass substrate and the rear glass substrate. A transparent electrically conductive coating is disposed at the second side of the front glass substrate and contacts the electrochromic medium. An electrically conductive coating is disposed at the third side of the rear glass substrate and contacts the electrochromic medium. The transparent electrically conductive coating at the second side of the front glass substrate is electrically connected to a first electrical connector at the fourth side of the rear glass substrate. The transparent electrically conductive coating at the second side of the front glass substrate is electrically connected to a second electrical connector at the fourth side of the rear glass substrate. A heating element is disposed at the fourth side of the rear glass substrate, and the heating element includes (i) an electrically conductive thin-film coating disposed at the fourth side of the rear glass substrate and (ii) a pair of connector elements in electrically conductive connection with the electrically conductive thin-film coating. With the vehicular rearview mirror assembly mounted at the vehicle, and when the heating element is electrically operated, electrical current flows between the pair of connector elements and electrically energizes the electrically conductive thin-film coating to generate heat at the mirror reflective element, such as to defrost or defog or deice the mirror reflective element.

These and other objects, advantages, purposes and features of the present invention will become apparent upon review of the following specification in conjunction with the drawings.

### BRIEF DESCRIPTION OF THE DRAWINGS

FIG. 1 is a view of an exterior rearview mirror assembly attached at a side of a vehicle;

FIG. 2 is a sectional view of an electrochromic mirror reflective element of the rearview mirror assembly;

FIG. 3 is a plan view of the mirror reflective element with a heater coating disposed at the rear surface of the mirror reflective element;

FIG. 4 is a sectional view of the electrochromic mirror reflective element with the heater coating disposed at the rear surface of the mirror reflective element;

FIG. 5 is a plan view of the mirror reflective element, showing distribution of heat across the mirror reflective element when electrical current is applied to the heater coating;

FIG. 6 shows example results of applying electrical current to the heater coating to defog the mirror reflective element;

FIG. 7 shows example results of applying electrical current to the heater coating to deice the mirror reflective element;

FIG. 8 is a chart showing example temperature changes experienced at the mirror reflective element over a 600 second test period for different combinations of heater coatings and types of electrical connectors;

FIG. 9 shows the heater coating as a continuous coating of electrically conductive material at the mirror reflective element; and

FIGS. 10 and 11 show the heater coating with ablation lines forming ablation patterns for guiding electrical current between electrical connectors.

### DESCRIPTION OF THE PREFERRED EMBODIMENTS

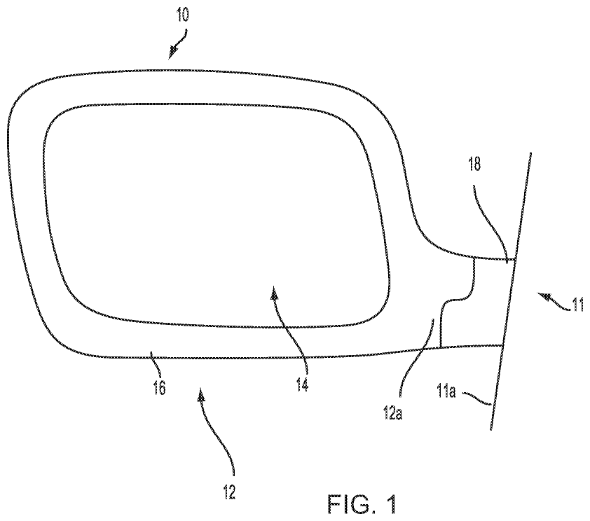

Referring now to the drawings and the illustrative embodiments depicted therein, an exterior rearview mirror assembly 10 for a vehicle 11 includes a mirror head 12 that includes a mirror reflective element 14 received in and/or supported at or by a mirror shell or casing 16 of the mirror head portion 12 (FIG. 1). The mirror head portion 12 includes a mounting portion 12a that may be pivotally or movably mounted to a mounting arm or base portion 18. The mirror assembly 10 may comprise a powerfold mirror (where the mirror head portion may be pivoted via an actuator assembly or adjustment device), and/or the mirror assembly may comprise a breakaway mirror (where the mirror head portion may be manually pivoted about the mounting arm or base). The mounting arm or base 18 of the mirror assembly 10 is mounted at the side 11a of the vehicle 11, with the reflective element 14 providing a rearward field of view along the respective side of the vehicle 11 to the driver of the vehicle 11. As discussed further below, the mirror reflective element 14 may include a heating element at a rear side of the mirror reflective element 14 that is electrically operable to heat the reflective element for defrosting or deicing or defogging the mirror reflective element 14.

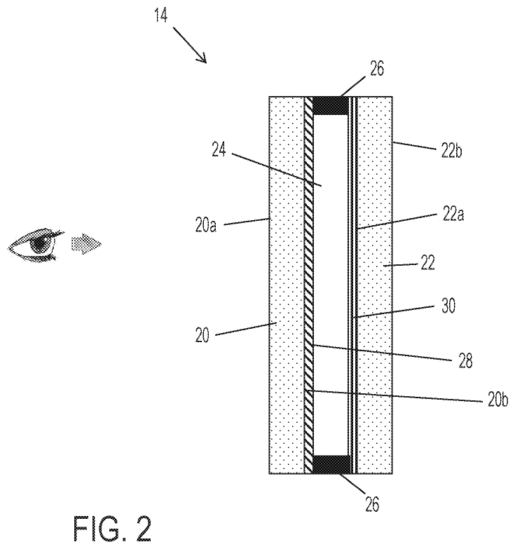

In the illustrated example, and as shown in FIG. 2, the mirror reflective element 14 comprises a laminate construction variable reflectance electro-optic (such as electrochromic) reflective element assembly having a front substrate 20 and a rear substrate 22 with an electro-optic medium 24 (such as electrochromic medium) sandwiched therebetween and bounded by a perimeter seal 26. As shown in FIG. 2, the front substrate 20 has a front or first surface 20a (the surface that generally faces the driver of a vehicle when the mirror assembly is normally mounted at the vehicle) and a rear or second surface 20b opposite the front surface 20a, and the rear substrate 22 has a front or third surface 22a and a rear or fourth surface 22b opposite the front surface 22a, with the electro-optic medium 24 disposed between the second surface 20b and the third surface 22a and bounded by the perimeter seal 26 of the reflective element. The second surface 20a of the front glass substrate 20 has a transparent conductive coating 28 established thereat (such as an indium tin oxide (ITO) layer, or a doped tin oxide layer or any other transparent electrically semi-conductive layer or coating or the like (such as indium cerium oxide (ICO), indium tungsten oxide (IWO), or indium oxide (IO) layers or the like or a zinc oxide layer or coating, or a zinc oxide coating or the like doped with aluminum or other metallic materials, such as silver or gold or the like, or other oxides doped with a suitable metallic material or the like, or such as disclosed in U.S. Pat. No. 7,274,501, which is hereby incorporated herein by reference in its entirety), while the third surface 22a of the rear glass substrate 22 has a metallic reflector coating 30 (or multiple layers or coatings) established thereat. The front or third surface 22a of the rear substrate 22 may include one or more transparent semi-conductive layers (such as an ITO layer or the like), and one or more metallic electrically conductive layers (such as a layer of silver, aluminum, chromium or the like or an alloy thereof), and may include multiple layers such as disclosed in U.S.

U.S. Pat. Nos. 7,274,501; 7,184,190 and/or 7,255,451, which are hereby incorporated herein by reference in their entireties. The mirror reflector may comprise any suitable coatings or layers, such as a transflective coating or layer, such as described in U.S. Pat. Nos. 7,626,749; 7,274,501; 7,255,451; 7,195,381; 7,184,190; 6,690,268; 5,140,455; 5,151,816; 6,178,034; 6,154,306; 6,002,511; 5,567,360; 5,525,264; 5,610,756; 5,406,414; 5,253,109; 5,076,673; 5,073,012; 5,115,346; 5,724,187; 5,668,663; 5,910,854; 5,142,407 and/or 4,712,879, which are hereby incorporated herein by reference in their entireties, disposed at the front surface of the rear substrate (commonly referred to as the third surface of the reflective element) and opposing the electro-optic medium, such as an electrochromic medium disposed between the front and rear substrates and bounded by the perimeter seal (but optionally, the mirror reflector could be disposed at the rear surface of the rear substrate (commonly referred to as the fourth surface of the reflective element).

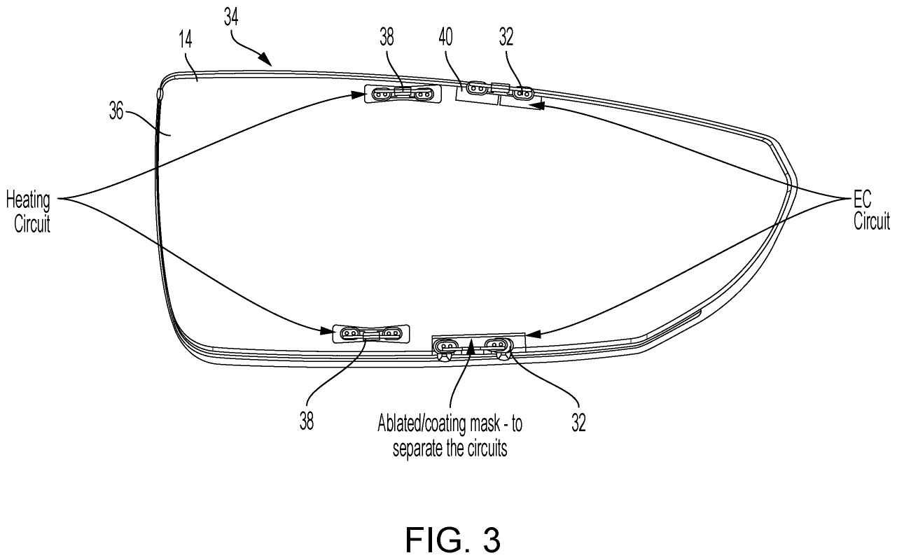

The third surface 22a defines the active EC area or surface of the rear substrate within the perimeter seal 26. The coated third surface 22a may also be coated to define a tab-out region (such as by utilizing aspects of the mirror assemblies described in U.S. Pat. Nos. 7,274,501; 7,184,190 and/or 7,255,451, which are hereby incorporated herein by reference in their entireties) for providing electrical connection of the conductive layers to an electrical clip of connector or bus-bar, such as the types described in U.S. Pat. Nos. 5,066,112 and 6,449,082, which are hereby incorporated herein by reference in their entireties. Electrical tabs or connectors 32 may be disposed at the fourth surface 22b of the rear glass substrate 22 for electrically connecting the electrochromic mirror to the wiring harness of the vehicle 11 (FIG. 3).

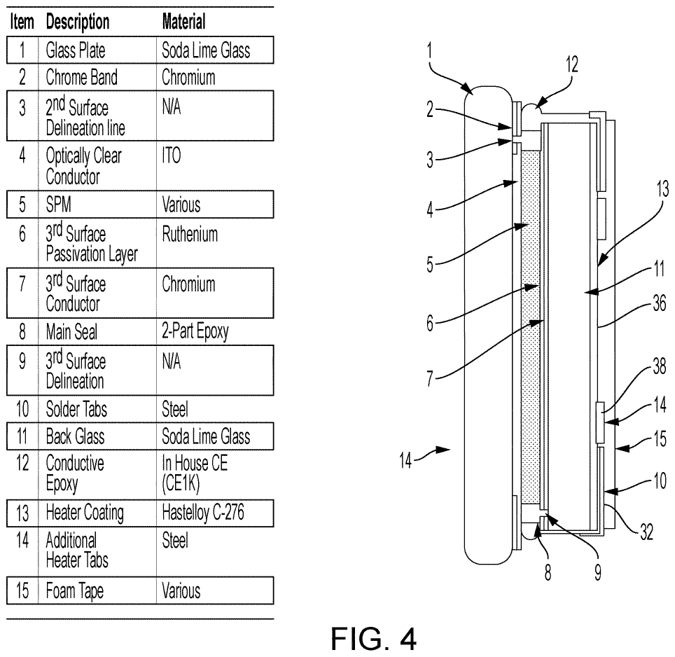

Referring to FIGS. 3-11, a heating element 34 of the mirror reflective element 14 includes an electrically conductive coating 36 disposed at the fourth surface 22b of the rear glass substrate 22 and electrical tabs or connectors or connector elements 38 disposed at the fourth surface 22b in electrically conductive connection with the heater coating 36. The heater coating 36 may comprise one or more layers (e.g., a stack of layers) of a continuous sheet coating or a thin-film coating or a coating that is ablated to tune resistance of the heating element 34, as discussed further below. For example, the heater coating 36 may include materials such as HASTELLOY™ C-276 alloy (i.e., a nickel-molybdenum-chromium-tungsten alloy) (e.g., having a resistivity of between about 1 micro Ohm-m to about 1.5 micro Ohm-m, such as about 1.3 micro Ohm-m), an aluminum alloy (e.g., having a resistivity of between about 25 nano Ohm-m to about 80 nano Ohm-m), chrome or chromium (e.g., having a resistivity of between about 125 nano Ohm-m to about 130 nano Ohm-m), ITO (e.g., having a resistivity of between about 5 Ohm/sq to about 100 Ohm/sq), aluminum-doped zinc oxide (AZO) (e.g., having a resistivity of between about 7 Ohm/sq to about 10.5 Ohm/sq), fluorine-doped tin oxide (FTO) (e.g., having a resistivity of between about 7 Ohm/sq to about 15 Ohm/sq), and the like. The heater coating 36 may comprise an environmentally stable electrically conductive thin-film coating applied at the fourth side 22b of the rear glass substrate 22 via use of a vacuum chamber. The tabs 38 may include electrically conductive solder, conductive epoxy, busbars, pogo pins, push pins, flexible printed circuits (FPCs), and the like. Voltage supplied to the heater coating 36 may be varied based on the heating power needed.

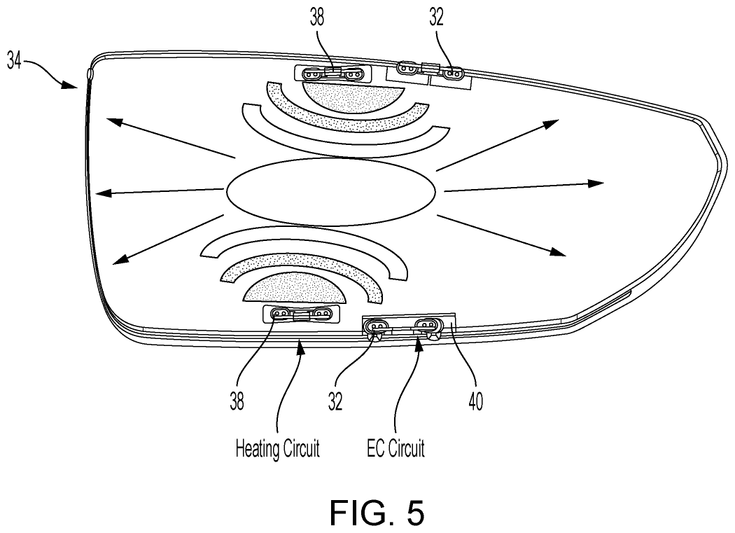

As shown in FIG. 5, when constant voltage is applied to the tabs 38 of the heating element 34, electrical current flowing through or across the coating between the tabs 38 may generate substantial heat at the rear surface 22b of the mirror reflective element 14. Because current travels along the path of least resistance, when the tabs 38 are in the center of the cell (e.g., at a central portion of an upper edge region of the mirror reflective element and a central portion of a lower edge region of the mirror reflective element), this causes a central portion of the mirror reflective element 14 to heat up faster before heat is conducted or radiates outward toward the peripheral edge regions of the mirror reflective element 14. Thermal conduction may transfer heat from the fourth surface 22b of the mirror reflective element 14 to the first surface 20a, and this heat may defog or deice or defrost the mirror reflective element 14 by melting or evaporating moisture at the front or first surface of the mirror reflective element.

Ablation lines or a coating mask 40 may be formed at the heater coating 36 at or near the tabs 32 connected to the EC cell to electrically isolate the tabs 32 from the heater coating 36. That is, because the heater coating 36 may be applied at the fourth surface 22b of the rear glass substrate 22 before the tabs 32 of the EC cell and the tabs 38 of the heating element are disposed at the fourth surface 22b, the tabs 32, 34 are subsequently electrically isolated from one another. For example, ablation lines may be formed in the heater coating 36 at or near the tabs 32 of the EC cell or the tabs 32 of the EC cell may be disposed at a mask disposed between the tabs 32 and the heater coating 36 to electrically isolate the tabs 32 of the EC cell from portions of the heater coating 36 in electrical connection with the tabs 38. Otherwise, without the ablation lines 40 electrically isolating the heating circuit from the dimming circuit, electrically charging the heating circuit might cause the EC to dim whenever heat is requested. Furthermore, the heating circuit may operate at up to about 10 times or more the voltage required for EC dimming.

In other words, a first electrical connection (one tab 32) is made at the fourth side 22b of the rear substrate 22 with the transparent electrically conductive coating 28, a second electrical connection (another tab 32) is made at the fourth side 22b of the rear substrate 22 with the electrically conductive coating 30, a third electrical connection (one tab 38) is made at the fourth side 22b of the rear substrate 22 with the heater coating 36, and a fourth electrical connection (another tab 38) is made at the fourth side 22b of the rear substrate 22 with the heater coating 36 spaced from the third electrical connection. Voltage applied to the first electrical connection and the second electrical connection causes the electrochromic medium to dim the mirror reflective element. Voltage applied to the third electrical connection and the fourth electrical connection causes electrical current to flow through or across the heater coating 36 between the third electrical connection and the fourth electrical connection to generate heat at the mirror reflective element. To prevent the voltage applied to the heater coating 36 from shorting the EC circuit, the first electrical connection and the second electrical connection are electrically isolated from the heater coating 36 and the third electrical connection and the fourth electrical connection. For example, ablation patterns electrically isolate the first and second electrical connections from the heater coating 36 or portions of a mask are disposed between the first and second electrical connections and the heater coating 36.

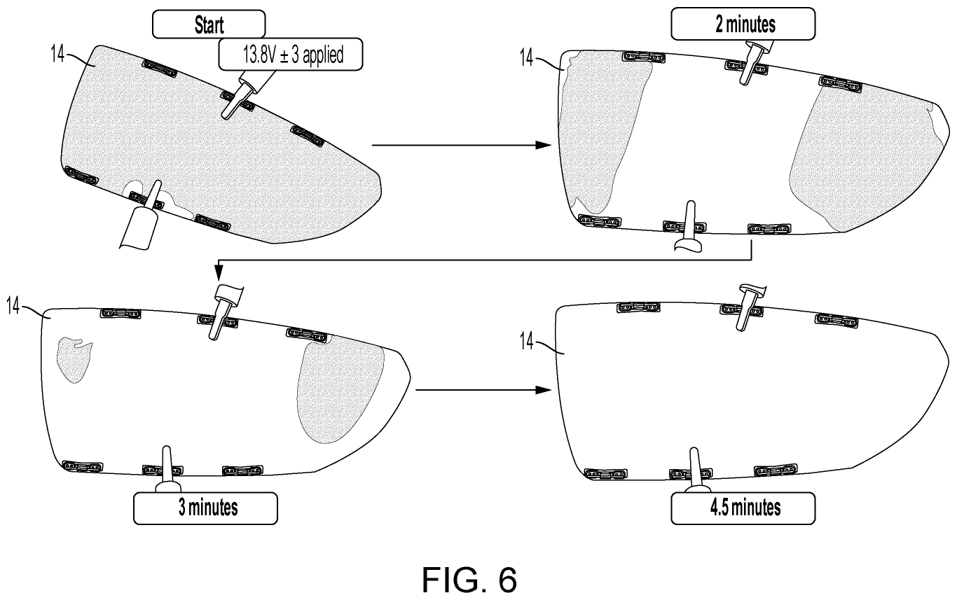

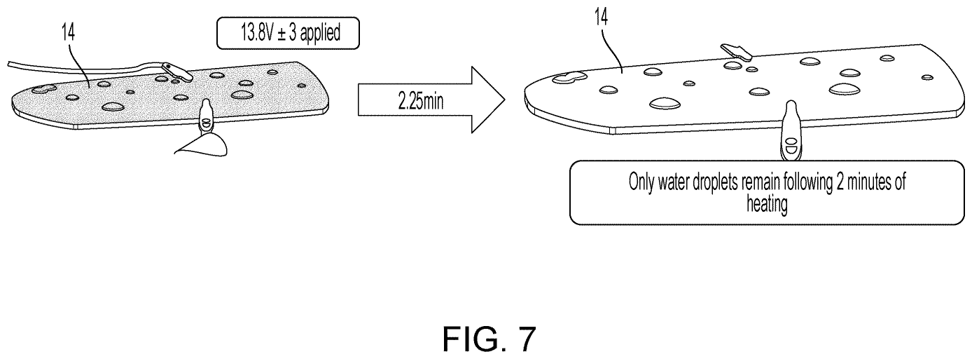

In the illustrated example of FIG. 6, electrical current may be applied to tabs 38 at the central portions of the upper and lower edge regions of the mirror reflective element 14, with the current traveling between the tabs 38 across the heating coating 36 to defrost the mirror reflective element 14. Between about 10.8 volts and about 16.8 volts, such as about 13.8 volts, may be applied. As shown, after about two minutes, frost at the central portion of the mirror reflective element 14 may be melted and/or dissipated. After about three minutes, substantially all of the frost at the mirror reflective element 14 may be melted and/or dissipated. After about 4.5 minutes, the mirror reflective element 14 may be devoid of frost and moisture. In the illustrated example of FIG. 7, ice at the mirror reflective element 14 may be substantially melted and/or dissipated following application of electrical current to the tabs 38 for about 2 to about 2.25 minutes or more.

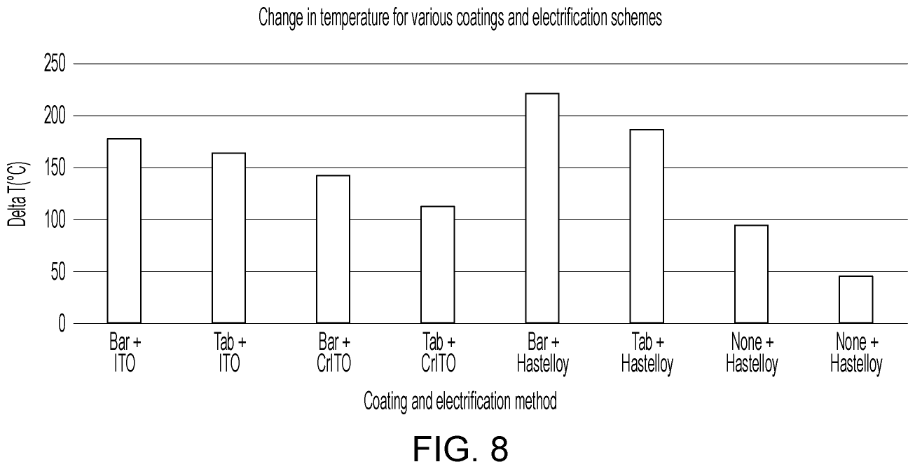

FIG. 8 shows example temperature change at the mirror reflective element 14 over a 600 second test period for different types of heater coating 36 and a variety of different electrical connectors 38. As shown, with the heater coating 36 including ITO and the electrical connectors 38 including busbars, a temperature change of about 175 degrees Celsius may be experienced at the mirror reflective element 14. With the heater coating 36 including ITO and the electrical connectors 38 including tabs, a temperature change of about 160 degrees Celsius may be experienced at the mirror reflective element 14. With the heater coating 36 including Cr and ITO and the electrical connectors 38 including busbars, a temperature change of about 145 degrees Celsius may be experienced at the mirror reflective element 14. With the heater coating 36 including Cr and ITO and the electrical connectors 38 including tabs, a temperature change of about 120 degrees Celsius may be experienced at the mirror reflective element 14. With the heater coating 36 including HASTELLOY™ C-276 alloy and the electrical connectors 38 including busbars, a temperature change of about 225 degrees Celsius may be experienced at the mirror reflective element 14. With the heater coating 36 including HASTELLOY™ C-276 alloy and the electrical connectors 38 including tabs, a temperature change of about 180 degrees Celsius may be experienced at the mirror reflective element 14. With the heater coating 36 including HASTELLOY™ C-276 alloy and with no electrical connectors directly disposed at the mirror reflective element, a temperature change of about 45 degrees Celsius to about 90 degrees Celsius may be experienced at the mirror reflective element 14 (the electrical current may be applied via clamps connected to a power source, as shown in FIGS. 6 and 7).

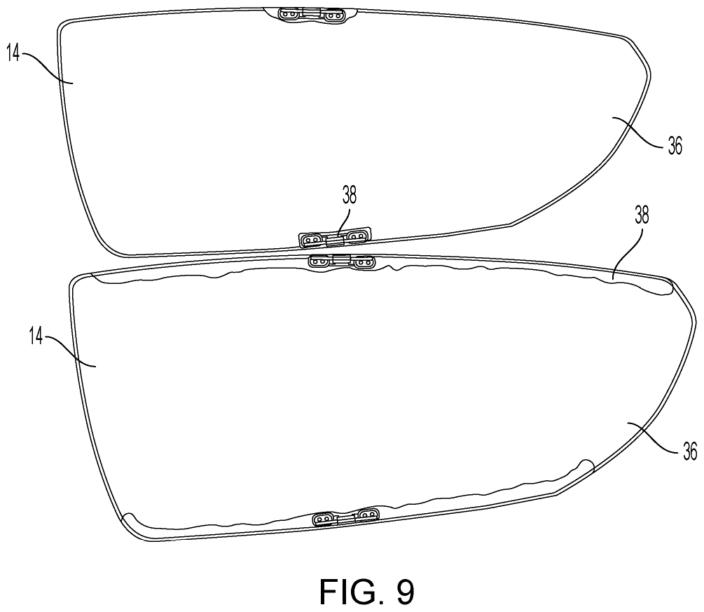

As shown in FIG. 9, the heater coating 36 may provide a continuous or unaltered coating at the fourth surface 22b of the mirror reflective element 14. Thus, the heat distribution may be heavily concentrated at central portions of the mirror reflective element and the edge regions of the glass may not heat unless the heater coating 36 is connected to power for several minutes or more. To improve thermal uniformity, the electrical connectors 38 may include respective lengths of conductive epoxy or busbar extending along the upper and lower edge regions of the mirror reflective element 14. Optionally, the heater coating 36 may vary in thickness at different portions of the fourth surface 22b of the mirror reflective element 14 to adjust the heating pattern of the coating. For example, a thicker deposit of the heater coating 36 may cause the corresponding portion of the mirror reflective element 14 to experience greater and/or faster heating than portions having thinner deposits of the heater coating 36.

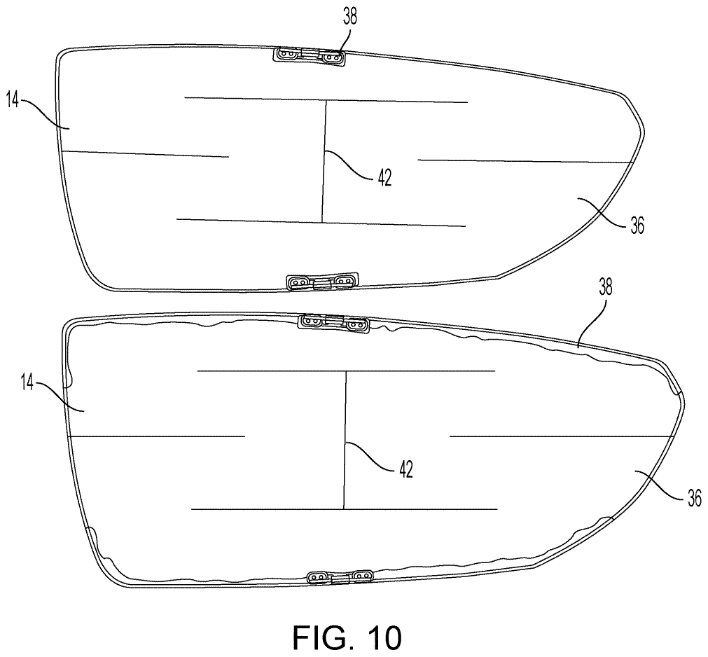

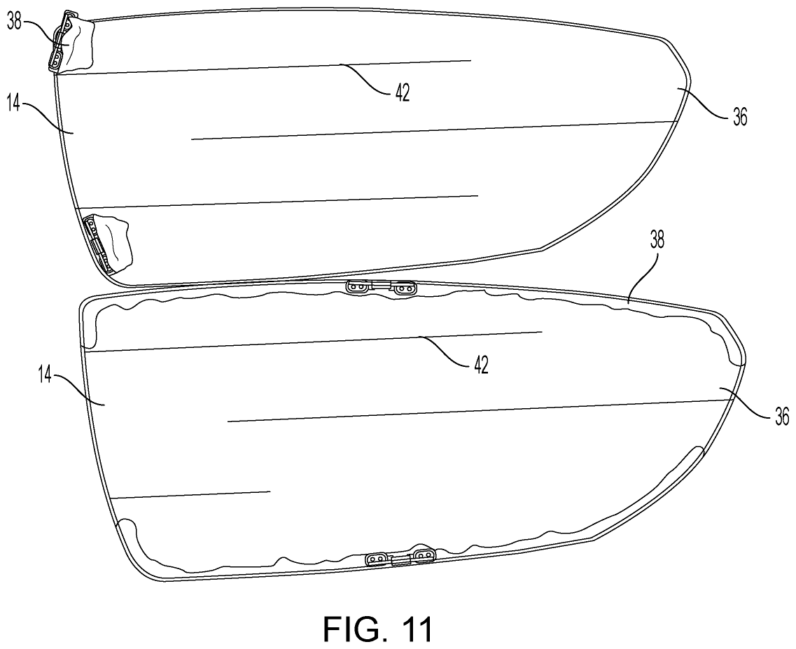

Further, one or more ablation lines or an ablation pattern 42 may be formed at the heater coating 36 to guide or direct current between the tabs 38 of the heating element 34 (FIGS. 10 and 11). Ablating in a maze or path for the electrical current to follow may increase the thermal distribution and uniformity, and may also increase the resistance of the heating element 34 at the fourth surface 22b. The ablation pattern 42 may be formed at the fourth side 22b at the same time as the ablation lines 40 electrically isolating the heater circuit from the EC circuit. That is, portions of the heater coating 36 may be removed to form the ablation lines 40, 42.

In the illustrated example of FIG. 10, the ablation pattern 42 includes an I-shaped maze, where electrical current from the connector 38 at the upper edge region of the mirror reflective element 14 may follow a split path along the heater coating 36 at both side regions of the mirror reflective element 14 toward the connector 38 at the lower edge region. In other words, the I-shaped ablation pattern 42 directs electrical current from one electrical connector 38 toward opposing sides of the mirror reflective element 14 along the upper edge region (i.e., at an upper bound of the I-shaped pattern), toward the central portion of the mirror reflective element 14 between the upper edge region and the lower edge region (i.e., between upper and lower bounds of the I-shaped pattern), and from the opposing sides of the mirror reflective element toward the central portion at the lower edge region (i.e., at the lower bound of the I-shaped pattern) and the other electrical connector 38. This may provide increased thermal uniformity and more uniform defrosting or deicing or defogging of the mirror reflective element 14. The mirror reflective element 14 may be slower to heat due to higher resistance. Optionally, the electrical connectors 38 may include a conductive epoxy or busbar extending along the upper and lower edge regions of the mirror reflective element 14 to further improve thermal uniformity and increase heating speed.

Referring to FIG. 11, the ablation pattern 42 may include a snake-shaped maze or winding or circuitous path, where the electrical connectors 38 may be respectively disposed at upper and lower portions of a side region of the mirror reflective element. The ablation pattern 42 may cause electrical current from the electrical connector 38 at the upper side region of the mirror reflective element 14 to follow a winding path along the heater coating 36 that passes along both sides of the mirror reflective element 14 and toward the electrical connector 38 at the lower side region. That is, the winding ablation pattern 42 directs electrical current from one electrical connector 38 along the upper edge region of the mirror reflective element, between opposing sides of the mirror reflective element 14 at the central portion of the mirror reflective element 14, and along the lower edge of the mirror reflective element toward the other electrical connector 38. This may provide high thermal uniformity and may lead to slower heating due to higher resistance. Optionally, the electrical connectors 38 may include a conductive epoxy or busbar extending along the upper and lower edge regions of the mirror reflective element 14 to further improve thermal uniformity and increase heating speed. Moreover, the heater coating 36 may include a lower resistance coating and/or have a higher thermal conductivity coefficient to improve speed of heating with the ablation pattern.

Optionally, the heater element and mirror assembly may utilize characteristics of the mirror assemblies described in International Patent Publication No. WO 2025231091, which is hereby incorporated herein by reference in its entirety.

The mirror assembly may utilize aspects of the mirror assemblies described in U.S. Publication Nos. US-2021-0331625; US-2021-0316664; US-2021-0213880; US-2020-0353867 and/or US-2020-0223364, and/or U.S. Pat. Nos. 11,325,535; 10,099,618; 9,827,913; 9,487,142; 9,346,403 and/or 8,915,601, which are all hereby incorporated herein by reference in their entireties.

Optionally, the heater element at the rear surface of the glass substrate may comprise a mirror defrost/demisting heater and may provide an anti-fogging of de-fogging feature to the exterior mirror assembly, and may utilize aspects of the heater elements or pads described in U.S. Pat. Nos. 9,481,304; 8,058,977; 7,400,435; 5,808,777; 5,610,756 and/or 5,446,576, and/or U.S. Pat. Publication No. 20080011733; which are hereby incorporated herein by reference in their entireties. The heater element may include electrical contacts that extend rearward therefrom and through an aperture of attaching portion of back plate for electrical connection to a wire harness or connector of the mirror assembly, or the back plate and/or heater element may include suitable electrical connectors and connections incorporated therein (such as by utilizing aspects of the mirror assembly described in U.S. Pat. No. 7,400,435, which is hereby incorporated herein by reference in its entirety) for electrically connecting the heater element (or other suitable electrical connectors may be utilized, such as electrical leads or wire harnesses or pigtails or other separate connectors or cables or the like). Optionally, the heater element may comprise a screen printed heater pad. For example, the heater element can be printed on the back of the mirror reflective element (such as at the fourth or rear surface of the rear substrate). Such coatings may be printed and then cured at around 120 degrees C or lower, making this process compatible with already formed laminate type EC mirror elements, such as those described in U.S. Pat. No. 5,724,187, which is hereby incorporated herein by reference in its entirety.

Optionally, it is envisioned that aspects of the present invention may be suitable for a rearview mirror assembly that comprises a non-electro-optic mirror assembly (such as a generally planar or optionally slightly curved mirror substrate) or an electro-optic or electrochromic mirror assembly. Optionally, the rearview mirror assembly may comprise a mirror assembly of the types described in U.S. Pat. Nos. 7,420,756; 7,289,037; 7,274,501; 7,338,177; 7,255,451; 7,249,860; 6,318,870; 6,598,980; 5,327,288; 4,948,242; 4,826,289; 4,436,371 and 4,435,042, which are hereby incorporated herein by reference in their entireties. A variety of mirror accessories and constructions are known in the art, such as those disclosed in U.S. Pat. Nos. 5,555, 136; 5,582,383; 5,680,263; 5,984,482; 6,227,675; 6,229,319 and 6,315,421 (which are hereby incorporated herein by reference in their entireties), that can benefit from the present invention.

Although shown and described as a mirror reflective element for an exterior rearview mirror assembly that mounts at a side of the vehicle, it should be understood that the electrochromic mirror reflective element is suitable for use in an interior rearview mirror assembly configured for mounting at an interior portion of the vehicle (e.g., at a windshield or headliner of a vehicle equipped with the mirror assembly) via mounting structure. For example, the interior rearview mirror assembly may include a mirror head including a mirror casing and the reflective element is positioned at a front portion of the casing. The mirror assembly may be configured to be adjustably mounted to the interior portion of the vehicle via the mounting structure or mounting configuration or assembly. The mirror casing and mirror reflective element may be adjustable together and in tandem with one another to set a rearward view provided to the driver.

The interior rearview mirror assembly may comprise any suitable construction, such as, for example, a mirror assembly with the reflective element being nested in the mirror casing and with a bezel portion that circumscribes a perimeter region of the front surface of the reflective element, or with the mirror casing having a curved or beveled outermost exposed perimeter edge around the reflective element and with no overlap onto the front surface of the reflective element (such as by utilizing aspects of the mirror assemblies described in U.S. Pat. Nos. 7,184,190; 7,274,501; 7,255,451; 7,289,037; 7,360,932; 7,626,749; 8,049,640; 8,277,059 and/or 8,529,108, which are hereby incorporated herein by reference in their entireties) or such as a mirror assembly having a rear substrate of an electro-optic or electrochromic reflective element nested in the mirror casing, and with the front substrate having a curved or beveled outermost exposed perimeter edge, or such as a mirror assembly having a prismatic reflective element that is disposed at an outer perimeter edge of the mirror casing and with the prismatic substrate having a curved or beveled outermost exposed perimeter edge, such as described in U.S. Pat. Nos. 9,827,913; 9,174,578; 8,508,831; 8,730,553; 9,598,016 and/or 9,346,403, and/or U.S. Des. Pat. Nos. D633,423; D633,019; D638,761 and/or D647,017, which are hereby incorporated herein by reference in their entireties (and with electrochromic and prismatic mirrors of such construction are commercially available from Magna Mirrors of America, Inc. under the trade name INFINITY™ mirror).

Changes and modifications in the specifically described embodiments may be carried out without departing from the principles of the present invention, which is intended to be limited only by the scope of the appended claims as interpreted according to the principles of patent law.

1. An electrochromic mirror reflective element, the electrochromic mirror reflective element comprising:
a front substrate having a first side and a second side separated from the first side by a thickness of the front substrate;
a rear substrate having a third side and a fourth side separated from the third side by a thickness of the rear substrate;
wherein the front substrate is joined with the rear substrate via a perimeter seal that bounds an electrochromic medium disposed in an interpane cavity between the front substrate and the rear substrate;
wherein a transparent electrically conductive coating is disposed at the second side of the front substrate and contacts the electrochromic medium;
wherein an electrically conductive coating is disposed at the third side of the rear substrate and contacts the electrochromic medium;
wherein a first electrical connection at the fourth side of the rear substrate electrically connects with the transparent electrically conductive coating at the second side of the front substrate;
wherein a second electrical connection at the fourth side of the rear substrate electrically connects with the electrically conductive coating at the third side of the rear substrate;
wherein, upon application of a voltage between the first electrical connection at the fourth side of the rear substrate and the second electrical connection at the fourth side of the rear substrate, the electrochromic medium disposed between the front substrate and the rear substrate electrically dims;
wherein a heating element is disposed at the fourth side of the rear substrate, and wherein the heating element comprises an electrically conductive thin-film coating disposed at the fourth side of the rear substrate;
wherein a third electrical connection at the fourth side of the rear substrate electrically connects with the electrically conductive thin-film coating;
wherein a fourth electrical connection at the fourth side of the rear substrate electrically connects with the electrically conductive thin-film coating, and wherein the fourth electrical connection is spaced from the third electrical connection at the fourth side of the rear substrate; and
wherein, upon application of a voltage between the third electrical connection at the fourth side of the rear substrate and the fourth electrical connection at the fourth side of the rear substrate, electrical current flows between the third electrical connection and the fourth electrical connection and generates heat at the electrochromic mirror reflective element.

2. The electrochromic mirror reflective element of claim 1, wherein the electrically conductive thin-film coating extends between perimeter edge regions of the fourth side of the rear substrate.

3. The electrochromic mirror reflective element of claim 2, wherein the electrically conductive thin-film coating comprises a continuous layer disposed at the fourth side of the rear substrate.

4. The electrochromic mirror reflective element of claim 2, wherein an ablation pattern is formed at the electrically conductive thin-film coating.

5. The electrochromic mirror reflective element of claim 4, wherein the ablation pattern comprises one or more ablation lines disposed at portions of the fourth side of the rear substrate between the third electrical connection and the fourth electrical connection, and wherein the ablation pattern is configured to cause electrical current flowing between the third electrical connection and the fourth electrical connection to electrically energize portions of the electrically conductive thin-film coating at perimeter edge portions of the fourth side of rear substrate and at a central portion of the fourth side of the rear substrate.

6. The electrochromic mirror reflective element of claim 4, wherein one or more ablation lines of the ablation pattern form an I-shape at the fourth side of the rear substrate.

7. The electrochromic mirror reflective element of claim 4, wherein one or more ablation lines of the ablation pattern form a winding path at the fourth side of the rear substrate.

8. The electrochromic mirror reflective element of claim 4, wherein the ablation pattern comprises one or more ablation lines that cooperate to electrically isolate the first electrical connection and the second electrical connection from the third electrical connection and the fourth electrical connection at the fourth side of the rear substrate.

9. The electrochromic mirror reflective element of claim 1, wherein a mask is disposed between the fourth side of the rear substrate and the first electrical connection and the second electrical connection, and wherein the mask (i) electrically isolates the first electrical connection and the second electrical connection from the electrically conductive thin-film coating and (ii) electrically isolates the first electrical connection and the second electrical connection from the third electrical connection and the fourth electrical connection at the fourth side of the rear substrate.

10. The electrochromic mirror reflective element of claim 1, wherein the first electrical connection is at a first region of the fourth side of the rear substrate, and wherein the second electrical connection is at a second region of the fourth side of the rear substrate, and wherein the third electrical connection is at a third region of the fourth side of the rear substrate, and wherein the fourth electrical connection is at a fourth region of the fourth side of the rear substrate, and wherein the third region and the fourth region electrically connect to the electrically conductive thin-film coating of the heating element, and wherein the first region and the second region are electrically isolated from the electrically conductive thin-film coating of the heating element.

11. The electrochromic mirror reflective element of claim 1, wherein the electrically conductive thin-film coating comprises a plurality of layers of electrically conductive material.

12. The electrochromic mirror reflective element of claim 1, wherein the electrically conductive thin-film coating comprises at least one selected from the group consisting of (i) a nickel-molybdenum-chromium-tungsten alloy layer, (ii) an indium tin oxide layer and (iii) a chromium layer.

13. The electrochromic mirror reflective element of claim 1, wherein the third electrical connection comprises a first connector element at an upper edge region of the electrochromic mirror reflective element, and wherein the fourth electrical connection comprises a second connector element at a lower edge region of the electrochromic mirror reflective element.

14. The electrochromic mirror reflective element of claim 1, wherein the third electrical connection comprises a first connector element at an upper portion of an edge region of the electrochromic mirror reflective element, and wherein the fourth electrical connection comprises a second connector at a lower portion of the edge region of the electrochromic mirror reflective element.

15. The electrochromic mirror reflective element of claim 1, wherein the electrochromic mirror reflective element comprises part of a vehicular exterior electrochromic rearview mirror assembly.

16. The electrochromic mirror reflective element of claim 1, wherein the electrochromic mirror reflective element comprises part of a vehicular interior electrochromic rearview mirror assembly.

17. An electrochromic mirror reflective element, the electrochromic mirror reflective element comprising:
a front substrate having a first side and a second side separated from the first side by a thickness of the front substrate;
a rear substrate having a third side and a fourth side separated from the third side by a thickness of the rear substrate;
wherein the front substrate is joined with the rear substrate via a perimeter seal that bounds an electrochromic medium disposed in an interpane cavity between the front substrate and the rear substrate;
wherein a transparent electrically conductive coating is disposed at the second side of the front substrate and contacts the electrochromic medium;
wherein an electrically conductive coating is disposed at the third side of the rear substrate and contacts the electrochromic medium;
wherein a first electrical connection at the fourth side of the rear substrate electrically connects with the transparent electrically conductive coating at the second side of the front substrate;
wherein a second electrical connection at the fourth side of the rear substrate electrically connects with the electrically conductive coating at the third side of the rear substrate;
wherein, upon application of a voltage between the first electrical connection at the fourth side of the rear substrate and the second electrical connection at the fourth side of the rear substrate, the electrochromic medium disposed between the front substrate and the rear substrate electrically dims;
wherein a heating element is disposed at the fourth side of the rear substrate, and wherein the heating element comprises an electrically conductive thin-film coating disposed at the fourth side of the rear substrate;
wherein a third electrical connection at the fourth side of the rear substrate electrically connects with the electrically conductive thin-film coating;
wherein a fourth electrical connection at the fourth side of the rear substrate electrically connects with the electrically conductive thin-film coating, and wherein the fourth electrical connection is spaced from the third electrical connection at the fourth side of the rear substrate;
wherein the third electrical connection comprises a first connector element at an upper edge region of the electrochromic mirror reflective element, and wherein the fourth electrical connection comprises a second connector element at a lower edge region of the electrochromic mirror reflective element;
wherein, upon application of a voltage between the third electrical connection at the fourth side of the rear substrate and the fourth electrical connection at the fourth side of the rear substrate, electrical current flows between the third electrical connection and the fourth electrical connection and generates heat at the electrochromic mirror reflective element; and
wherein an ablation pattern is formed at the electrically conductive thin-film coating, and wherein the ablation pattern comprises one or more ablation lines that cooperate to electrically isolate the first electrical connection and the second electrical connection from the third electrical connection and the fourth electrical connection at the fourth side of the rear substrate.

18. The electrochromic mirror reflective element of claim 17, wherein the electrochromic mirror reflective element comprises part of a vehicular exterior electrochromic rearview mirror assembly.

19. An electrochromic mirror reflective element, the electrochromic mirror reflective element comprising:
a front substrate having a first side and a second side separated from the first side by a thickness of the front substrate;
a rear substrate having a third side and a fourth side separated from the third side by a thickness of the rear substrate;
wherein the front substrate is joined with the rear substrate via a perimeter seal that bounds an electrochromic medium disposed in an interpane cavity between the front substrate and the rear substrate;
wherein a transparent electrically conductive coating is disposed at the second side of the front substrate and contacts the electrochromic medium;
wherein an electrically conductive coating is disposed at the third side of the rear substrate and contacts the electrochromic medium;
wherein a first electrical connection at the fourth side of the rear substrate electrically connects with the transparent electrically conductive coating at the second side of the front substrate;
wherein a second electrical connection at the fourth side of the rear substrate electrically connects with the electrically conductive coating at the third side of the rear substrate;
wherein, upon application of a voltage between the first electrical connection at the fourth side of the rear substrate and the second electrical connection at the fourth side of the rear substrate, the electrochromic medium disposed between the front substrate and the rear substrate electrically dims;
wherein a heating element is disposed at the fourth side of the rear substrate, and wherein the heating element comprises an electrically conductive thin-film coating disposed at the fourth side of the rear substrate;
wherein a third electrical connection at the fourth side of the rear substrate electrically connects with the electrically conductive thin-film coating;
wherein a fourth electrical connection at the fourth side of the rear substrate electrically connects with the electrically conductive thin-film coating, and wherein the fourth electrical connection is spaced from the third electrical connection at the fourth side of the rear substrate;
wherein, upon application of a voltage between the third electrical connection at the fourth side of the rear substrate and the fourth electrical connection at the fourth side of the rear substrate, electrical current flows between the third electrical connection and the fourth electrical connection and generates heat at the electrochromic mirror reflective element;
wherein the first electrical connection is at a first region of the fourth side of the rear substrate, and wherein the second electrical connection is at a second region of the fourth side of the rear substrate, and wherein the third electrical connection is at a third region of the fourth side of the rear substrate, and wherein the fourth electrical connection is at a fourth region of the fourth side of the rear substrate, and wherein the third region and the fourth region electrically connect to the electrically conductive thin-film coating of the heating element, and wherein the first region and the second region are electrically isolated from the electrically conductive thin-film coating of the heating element; and
wherein an ablation pattern is formed at the electrically conductive thin-film coating, and wherein the ablation pattern comprises one or more ablation lines disposed at portions of the fourth side of the rear substrate between the third electrical connection and the fourth electrical connection, and wherein the ablation pattern is configured to cause electrical current flowing between the third electrical connection and the fourth electrical connection to electrically energize portions of the electrically conductive thin-film coating at perimeter edge portions of the fourth side of rear substrate and at a central portion of the fourth side of the rear substrate.

20. The electrochromic mirror reflective element of claim 19, wherein the electrochromic mirror reflective element comprises part of a vehicular exterior electrochromic rearview mirror assembly.
